(19) United States
(12) Patent Application Publication
(10) Pub. No.: US 2006/0178977 A1
(43) Pub. Date: Aug. 10, 2006

(54) Online auction promotion method

(76) Inventors: Michel Chapelle, Irvine, CA (US); Corinne Chapelle, Irvine, CA (US)

Correspondence Address: Jeffrey A. Travis, 1621 Mesa Dr. #9, Santa Ana, CA, 92707, US

(21) Appl. No.: 11/051,153

(22) Filed: Feb. 7, 2005

(51) Int. Cl. G06Q 40/00

(52) U.S. Cl. 705/37; 705/39

(57) ABSTRACT

A method in a computer system for conducting a reward structure and implementing commissions in an online auction comprising the steps of: online consumers providing one or more items for bid on the online auction; the online auction announcing a drawing with a reward for the completed sales of any one of the items; online consumers completing sales for the items on the auction; the service provider receiving notification of the completed sales; sending a request to either one of the online consumers for a voluntary commission; receiving the voluntary commission from either one of the online consumers; issuing unique tickets to the successful bidders and successful sellers for their completed sales; entering the tickets into the drawing; selecting a winning ticket through a computer generated process at the time of the promotional event; and giving the reward to the winning ticket holder.

### BACKGROUND OF THE INVENTION

1. Field of the Invention

The present invention relates to the field of online commercial transactions. More specifically, the present invention relates to promotions for attracting and retaining online consumers and commissions relating to online auctions.

2. Description of the Related Art

The Internet has become a bastion of commerce of just about every trade in little more than a decade. Even more so, just as many ways to commence these commercial transactions have appeared in about as little time. One of the means of commencement is through auctions conducted online.

Similar to real world auctions, online auctions have a seller, bidder, auctioneer, and a method of payment. A general schematic of an online auction system is presented in FIG. 1 whereby a remote server (1) (the auctioneer) provides access to and from information stored on a database (2) and a client program on the server (3) serves up content—usually HTML pages through the Internet—to remote clients. The program provides a way for the remote clients to place auction items for bid and, in turn, for others to place bids on those auction items online. Most auctions are timed to end at a designated time with the highest bid at the end of the designated time being the winner. Once a winner is determined, notification is sent to the winning bidder (buyer) and seller and payment occurs. It is the flow of commerce between these two—sellers and bidders—that provides most of the revenue for online auction service providers. (OASP's)

The online auction market has seen growth of which online auction leader e-Bay hosts approximately 4.5 million auctions a day. It has built up a community of 37.5 million users in 20 countries and, according to Jeetl Patel, senior e-commerce analyst at Deutsche Bank Alex Brown, e-Bay is on track to pull in one billion dollars in revenues next year and record 70% earnings growth for the next two years. Amazon.com is estimated to have approximately 470,000 auctions a day and Yahoo! has more than 250,000. Even setting up an online auction has become commonplace with some online services offering instant, customized auction sites providing many of the standard auction services necessary to conduct one.

Despite their growth, online auctions have been plagued by persistent problems affecting both consumers and the auction providers. One of the biggest problems with online auctions has been the constant surcharges, fees, and commissions placed on those who place items for bid. In the auction industry, a typical Internet auction transfers into the virtual world the traditional brick-and-mortar approach of doing business, which consists of receiving a fee for each listed item plus a commission based on a percentage of the final sale price value. For “power sellers”, those who sell in upwards of hundreds and thousands of multiple simultaneous auctions a day, this approach of constant changes in commission and regulation with not enough time to make the appropriate correction on each item, costs them money and has created an aura of discontent among frequent users of online auctions such as e-Bay. Their complaints are published in online newsletters for the auction industry such as The Auction Guild Notes (TAGnotes) and Auctionbytes.com. A January, 2002 editorial in TAGnotes, “e-Bay A Solution Now!!!” expresses the extreme discontent many auction users are feeling at the excessive fees and lack of control they have over current methods of conducting online auctions.

Further, the cost of acquiring new customers, a benchmark of any company's health on the Internet, has been in the average of $18.50 to $22.00. In an article about Priceline.com in the Wall Street Journal, Jul. 23, 2000, Anthony Note, an analyst for Goodman Sachs Group Inc., is quoted as saying, “the actual Priceline.com ratio is $10.81, down from $13.25 a year ago.” This is one of the lowest ratios in the industry. It is well known in this field that companies on the Internet have never had a good handle on customer acquisition cost. They tend to put more and more dollars into advertising. A constant dilemma for most consumer-oriented Internet businesses is whether growth will continue if they stop.

Dr. Norton Smith, Nobel Prize 2003 winner in Economics and a professor at George Mason University has found that contrary to conventional methods of doing business, when a person knows that you defer a decision to him/her they return the favor by a fair decision. Dr. Norton Smith outlined some “theories and models” on how commerce can possibly be enhanced through respect and reciprocation. Therefore, instead of a “rational” or selfish model commonly imposed by commercial transactions, a method of respect and reciprocation where the other has power over the monetary decision of the sale would seem to cause that person to reciprocate the trust through a fair decision that satisfies both the seller and the provider of the services, and fidelity to the site as return business.

As explained above, the current model for online auctions has been to leave all final price value commission to the discretion of the online auction services provider. What is needed is a way to apply the benefits of respect or “respect and reciprocation” or, “trust reciprocation” to promote sales, customer satisfaction, and attract new customers in an online auction by lowering the sale price due to the effect of the free will commission that allows the sellers to save on their overhead expenses and eventually to pass part of their saving to their customers, thereby enhancing sales volume.

### SUMMARY OF THE INVENTION

One aspect of the present invention is a method for implementing an auction reward structure as a privilege to successful bidders and sellers of auction items. A promotion—usually a drawing with a monetary reward—is announced and implemented whereby tickets are given for completed sales of auction items. (“Ticket” is used here as a symbol word and is merely a unique identifier of the buyer or seller to a completed sale of an auction item.) Further, the auction reward structure is typically staggered to take place at multiple times a day.

Another aspect of the present invention is related to a method for allowing sellers to set their own commission by voluntarily contributing some value to the online auction service provider once a sale has been completed. In a preferred embodiment of the present invention, the free will commission is a percentage of the total final sale price value of the completed sale. In another embodiment of the present invention the free will commission is some monetary unit as a voluntary contribution to the online auction service provider. Another alternative is to have the voluntary contribution be a portion of the value of a future completed sale.

### BRIEF DESCRIPTION OF THE SEVERAL VIEWS OF THE DRAWINGS

FIG. 1 is a general schematic of an online auction system with a central server, information stored on a database, and a web program accessible by remote clients.

FIG. 2 shows a block diagram of the online auction reward structure promotion process.

FIG. 3 is a logical flow diagram of the online auction reward structure promotion process.

FIG. 4 is a block diagram of an online auction with a free will commission.

FIG. 5 is a partial logical flow diagram of an online auction with free-will commission as a basis of fees on final sale price value.

FIGS. 6A, 6B, 6C, 6D, 6E, and 6F describe a model business plan implementing the online auction method of the present invention with the auction drawing and free will commission elements.

FIG. 7 shows a computer display for a client seller in an online auction requesting a voluntary commission.

### DETAILED DESCRIPTION OF THE DRAWINGS

Overview

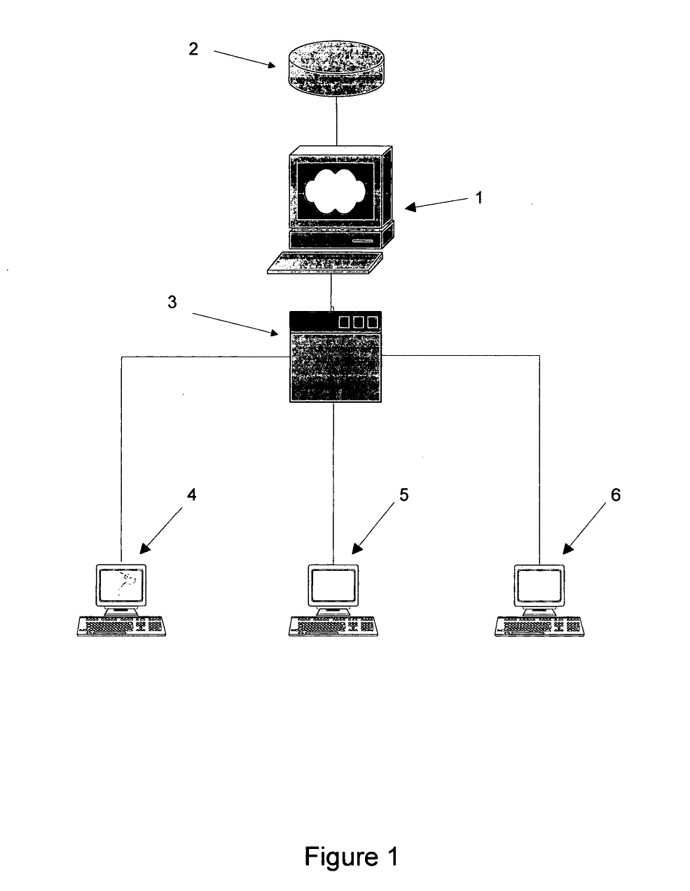

The present invention is illustrated in FIGS. 1 through 13, which show a system and method for promoting trust reciprocation between online auction users and the Online Auction Service Providers (OASP). Although the preferred embodiments for each are described in detail below, they also embody certain principles of methodology whereby reasonable practitioners in the art will readily ascertain modifications not explicitly laid out, yet still fit within the same principles described herein.

The online auction method of the present invention combines two principles of online exchange that will better foster trust-reciprocation between the online auction users and the OASP than has been done and is currently being implemented. The two principles are those of daily auction rewards for a set amount of money occurring over multiple and successive periods of time of which the number will increase progressively and a free will commission element where online auction users are asked to determine their own commissions.

Promotional Auction Reward Structure

As a way to promote trust reciprocation between online auction consumers and OASP's, the present invention implements a method of trust-reciprocation through elimination of arbitrary fees commission on the final sale price value. One means for creating incentives to use an online auction is through an auction drawing or jackpot. An entry in a promotional event such as a drawing is a privilege and reward for online consumers for completing sales of auction items and as a more effective means for creating an incentive to increase consumer growth through satisfaction and return customers.

Here, online consumers are taken to be all those who participate and benefit from online auctions. These include, but are not limited to, sellers who place their bid on the online auction and buyers who view these bids and make bids on these items in hopes of purchasing them. Online consumers are further classified in the field as “power sellers”—those who sell upwards of hundreds and thousands of multiple simultaneous auctions a day—and those who sell in smaller volumes or those who sell in the Internet stores.

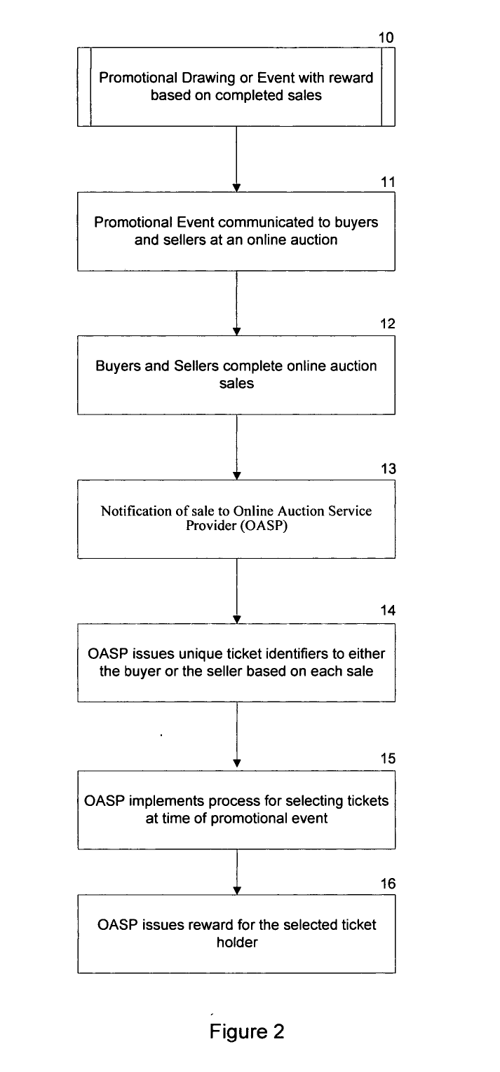

FIG. 2 shows a block diagram of an online auction promotion method whereby an OASP implements a promotional event for participating in the online auction (10); communicates the event to online consumers (11); the online consumers complete auction sales (12); a notification of a completed sale is sent to the OASP (13); a unique ticket is issued to the buyer and the seller based on the completed sale (14); the OASP selects a ticket from the total pool of tickets at the time of the promotional event (15); and the OASP issues a reward to the chosen ticket holder (16). This method is then repeated in a given period of time in order to attract new customers and to retain current ones.

A promotional event is inclusive of any type of promotion that will give incentives to buyers and sellers to complete auction transactions through the OASP. In the preferred embodiment, the event is a “drawing”—a random selection of tickets at a predetermined time. Promotional events may also be non-random with the promotional reward given to the online auction consumer with the highest repeat buyer, sale, or some other selected criteria for determining a reward and will eventually lead to an increased interest in the OASP that will, in turn, lead to more sales and repeat consumers.

Completed sales is the preferred criteria for awarding tickets entered into an auction drawing, although, those skilled in the art will readily notice that drawings can also be used as added incentives for mere participation in the auction, as an added incentive for auction use, as a reward for customer loyalty, or any other reward that will induce satisfaction and bolster the growth of the auction.

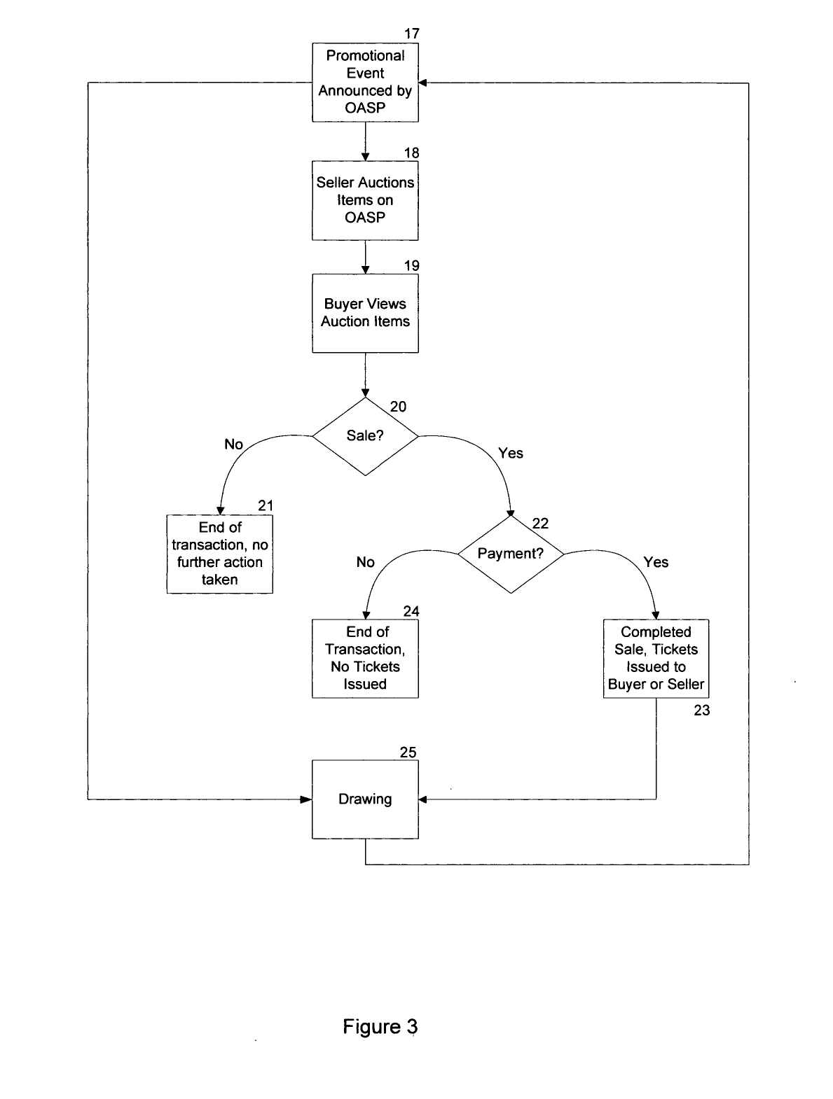

FIG. 3 depicts a logical flow diagram of the auction reward structure in its simplest form. Once a promotional event is established, it is announced to online consumers (17). Announcement is taken here to mean any form of communication of the promotional event such as traditional advertisements, email notification to online consumers, word-of-mouth, or any other effective mode of communication readily known in the art. It is usually incumbent on the OASP to notify past, current, or potential online consumers of the promotional event. Methods in the art that will satisfy notification function to 1) attract new consumers, 2) create an incentive for the continued use of the OASP, and 3) create a climate of mutual trust through reward programs of a chain of drawings that benefit the consumers.

Once a seller is attracted to the online auction and auctions their items (18), a buyer will then view the auction item and then either elect to purchase or reject the auction item (19). If the buyer rejects the item, the transaction is incomplete and no ticket is issued by the OASP (21). Completed sales are essential to the present invention unlike other methods of encouraging sales in relevant art. A completed sale is accomplished when the buyer elects to purchase the auction item (20) and also makes payment for the auction item (22). A sale without payment ends the transaction and no further action is taken by the OASP (24). After a completed sale (23) occurs, a reward ticket is issued to both the buyer and the seller. In the preferred embodiment of the present invention, tickets should be awarded to both buyer and seller since it will provide for added incentive to achieve trust reciprocation between not only the OASP and the seller, but also the OASP and the buyers.

Tickets, as referenced in (14) in FIG. 3 describe a unique identifier tagged to the seller and buyer for each completed sale. Creating unique identifiers for transactions is readily known in the art and can be easily done by joining the client authentication information—usually the same as is used when authenticated on the OASP—of each party to the sale to a randomly generated key identifier. In this way, all tickets are unique from each other and allows for multiple tickets to be issued to buyers and sellers for multiple completed sales. In a preferred embodiment, the tickets can be stored on the OASP server databases and copied to the parties by email.

After a completed sale (23) in FIG. 3, tickets are entered into the drawing. It is important to note that the object of the present invention is to conduct ongoing drawings and so, while the ticket being issued will go to a drawing, there could have been any number of drawings that have taken place from the time of the initial offer for sale of the auction item to the time of the completed sale. FIG. 3, reference numeral (23), shows a completed sale and a ticket being issued and entered into the drawing (25). Whether a sale is completed will not necessarily determine whether or not a drawing will occur. As such, FIG. 2 only shows one possible completed sale, but if the sale did not complete in the specific instance of FIG. 3, the drawing (25) would have still commenced and after that a new drawing or promotional event would have been announced and the method would be repeated.

Once the promotional event (15) commences, a selection process begins that selects from a pool of the total number of tickets issued for the designated period. The promotional event is preferably a drawing, where a random process is used to randomly select from a pool of tickets issued in a designated period. Software programs that can randomly select unique identifiers, such as tickets from a database, are readily known in the art. Further, the software program can choose between one or more tickets and as such, can give one or more rewards based on the parameters of the auction drawing.

In the preferred embodiment of the online auction drawing method, the reward (16) is a set monetary reward issued in a drawing after a designated time period. However, any type of reward that induces sales will be sufficient.

Free-Will Commission (F.W.C)

One of the primary advantages to the present invention over all other relevant art is that of free-will commission. Free-will commission is a voluntary commission given by the online consumer to the OASP upon the completion of a sale. For OASP's implementing free-will commissions, there are no pre-established commissions and the OASP defers the commission to the online consumer who is responsible for pricing the service rendered. In one embodiment, if an online consumer remains a non-contributor to any completed auction transaction, they will be informed that their entry privilege in the reward structure and temporarily suspended until such time they decide to choose to participate in a future reward through a future sale.

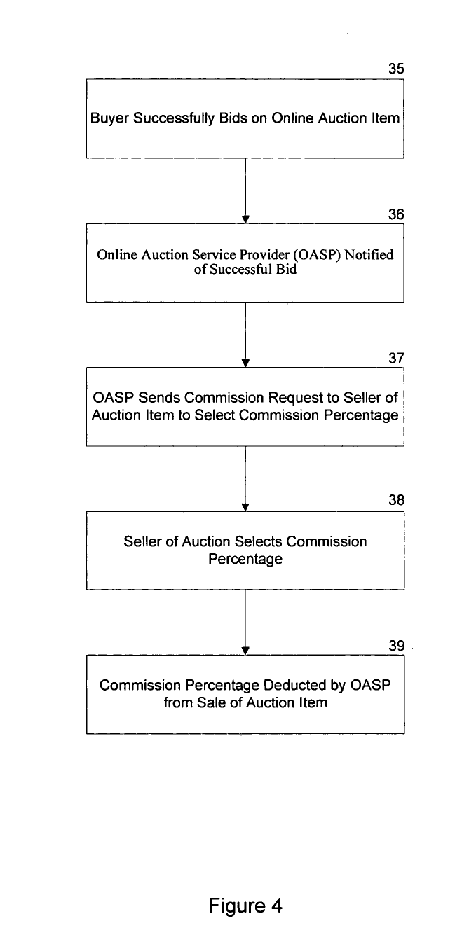

As shown in FIG. 4, the method for how the online auction occurs is not changed. A sale must be completed (35); the OASP is notified of the successful bid and sale (36); and the OASP sends a notification to the seller (37) of the recently purchased auction item asking them to select a percentage of the total sale as a commission to the OASP (38) or, the seller may elect to pay any monetary amount.

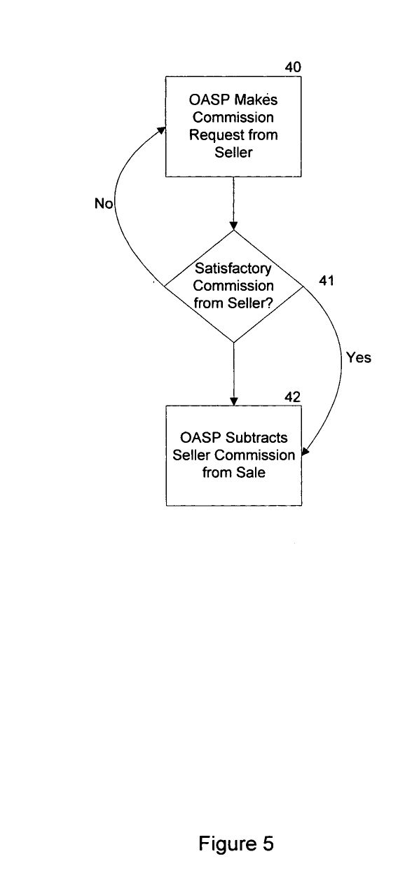

A logical flow of the free-will commission is illustrated in FIG. 5 where after the sale is completed and tickets are issued (23) as in FIG. 3, the OASP makes a commission request from the seller (40). The seller will then either make a satisfactory voluntary contribution based on a criterion set by the OASP (41) at which time the OASP can then subtract the total amount from the sale from an account on their server or other means for collecting payment (42). It is expected that the OASP will not require any minimum contribution from the seller. Still, if the voluntary contribution must satisfy a minimum amount that is insignificant relative to the total sale, the purpose of deferring the commission to the seller and generating trust reciprocation should not be defeated.

An online auction is only one means whereby a free-will commission can be implemented. In any online transaction that requires commissions or fees as a basis of revenue—sole or otherwise—trust-reciprocation methodology can apply. For example, for fees and commissions as a result of buyer-driven transactions, like those used by Priceline.com (U.S. Pat. No. 5,794,207) where a prospective buyer provides a binding purchase price, prospective buyers may also volunteer commissions or fees as a condition of the sale.

In another embodiment of establishing a voluntary commission based on paying some amount—no matter how small, if the commission does not satisfy the criterion, another notification is then sent to the seller to make a contribution or else the sale will not be considered complete (40).

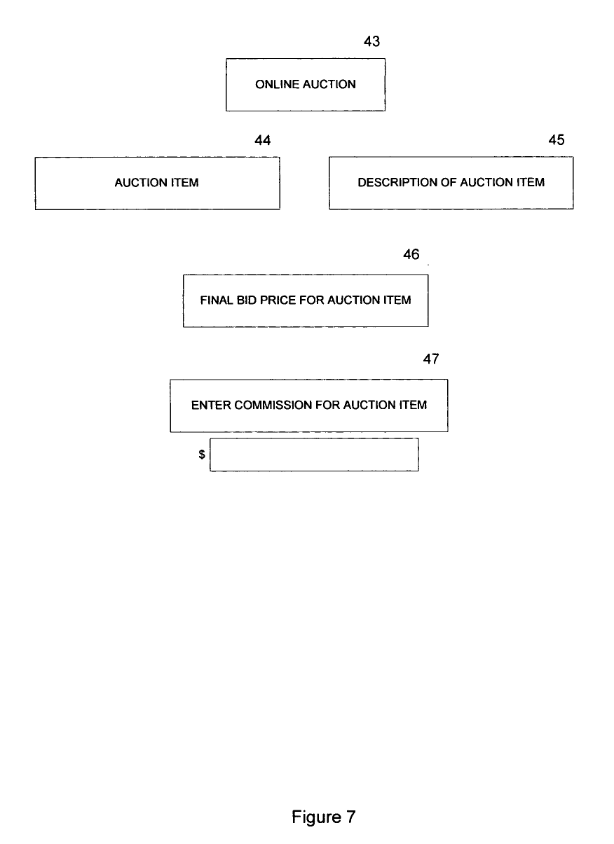

Free-will commission is further illustrated by FIG. 7, which depicts a software program that is accessible by the remote client system. In FIG. 7 an online auction service provider has received notification of a sale and has returned to the remote client bidder a title (43), auction item and description (44) (45), and sale price of the auction item (46). The bidder is then prompted to enter a commission amount (47). In FIG. 7, as in the block and logical flow diagrams of FIGS. 1, 2, 3, 4, and 5, the amount desired can be purely voluntary, or requiring a minimum amount either as a percentage or a set monetary amount.

Since participation in auction rewards is a privilege, a preferred method of establishing online auction standards for free-will commissions is to allow tickets to be entered for those who do voluntarily contribute and complete a sale, and for those who choose not to participate to suspend them from future rewards with their suspension to be terminated once they complete another sale and voluntarily contribute.

In yet another embodiment, a seller is asked to pay a minimum amount either as a percentage or as a flat monetary value to the OASP. To increase sales and to increase the potential number of free-will commissions, buyers can also be notified with a free-will commission request from the OASP subject to the same or different voluntary commissions.

Proposed Implementation of Trust-Reciprocation Model

A specific implementation of the present invention utilizing an auction reward structure in coordination with a Free Will Commission is described in more detail below.

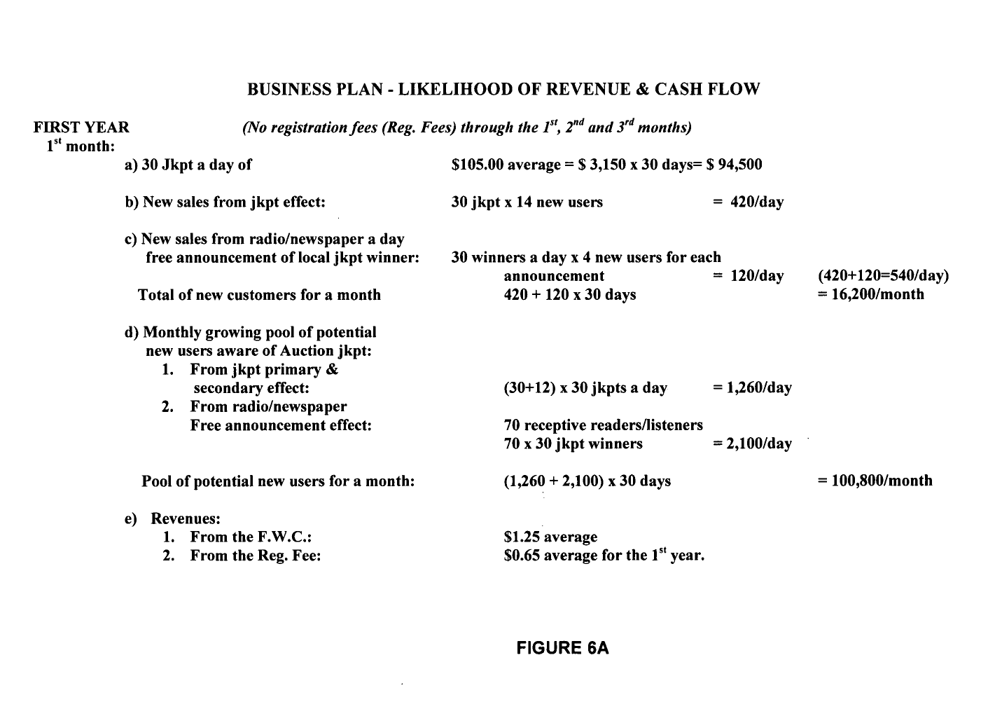

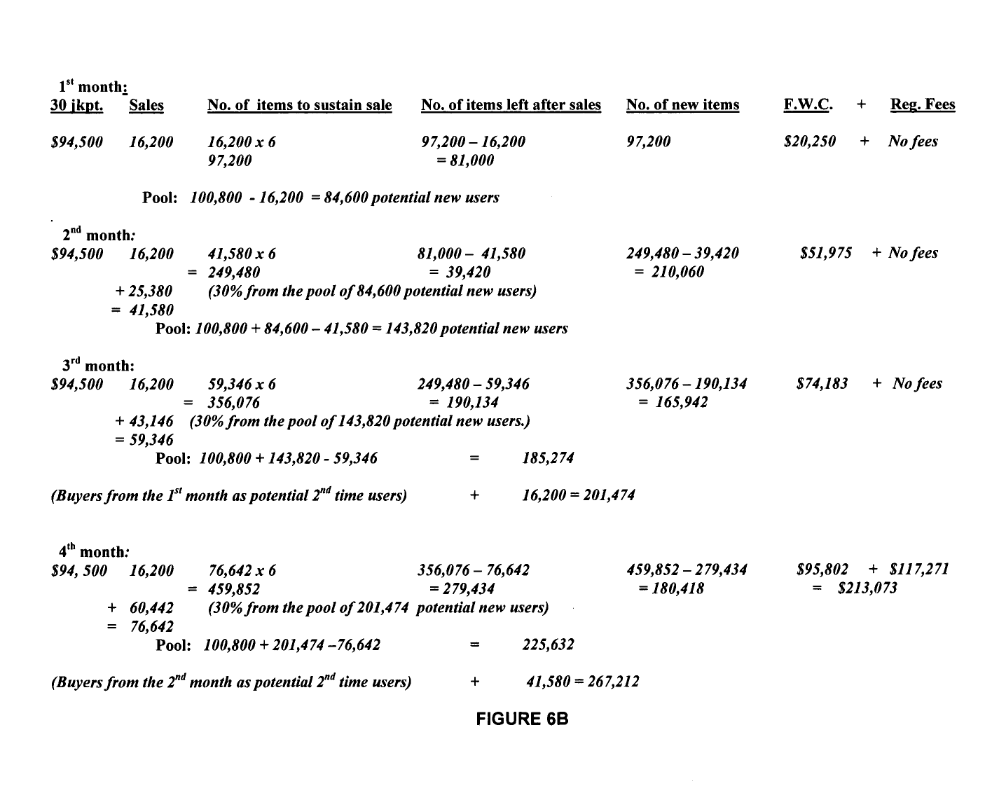

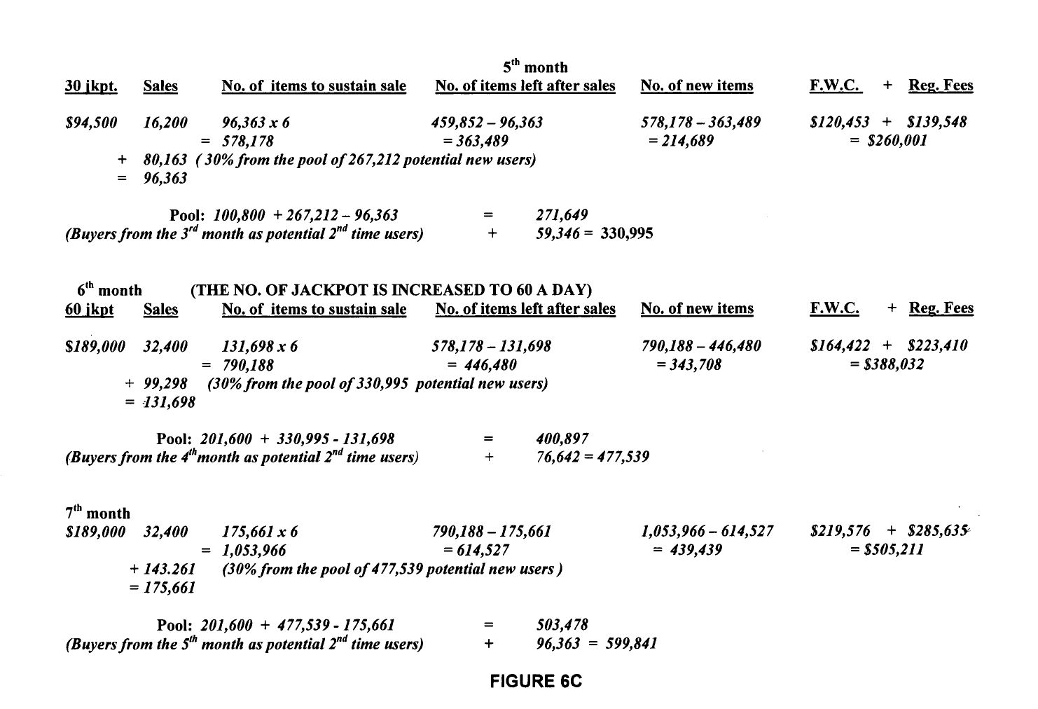

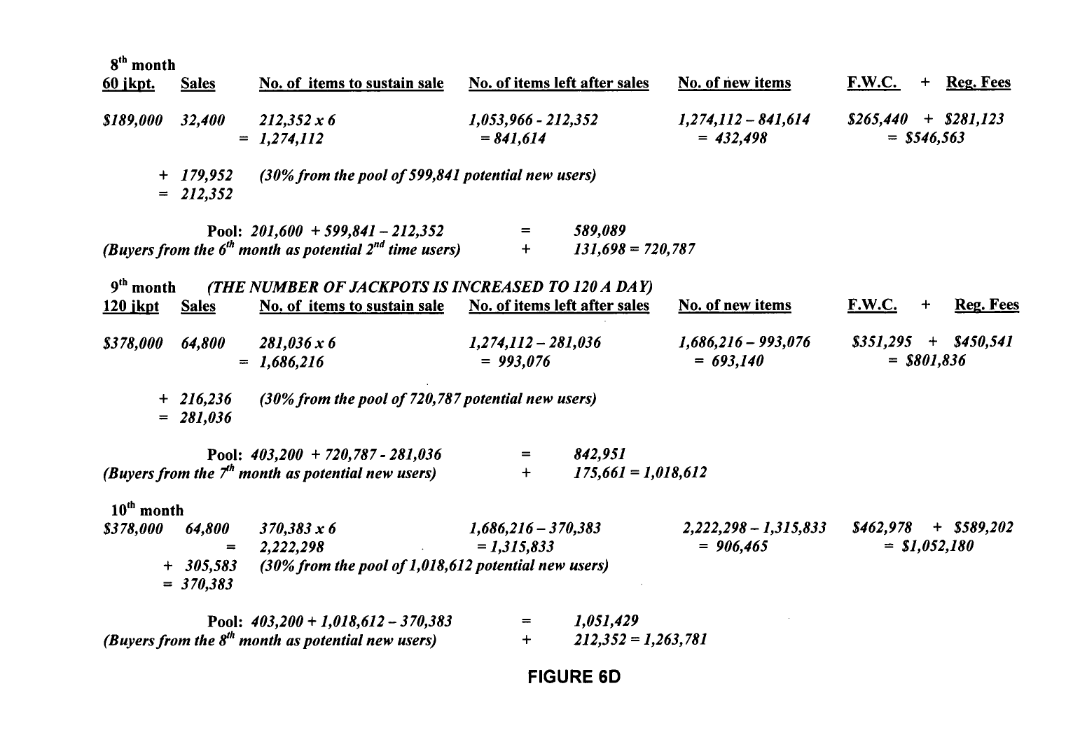

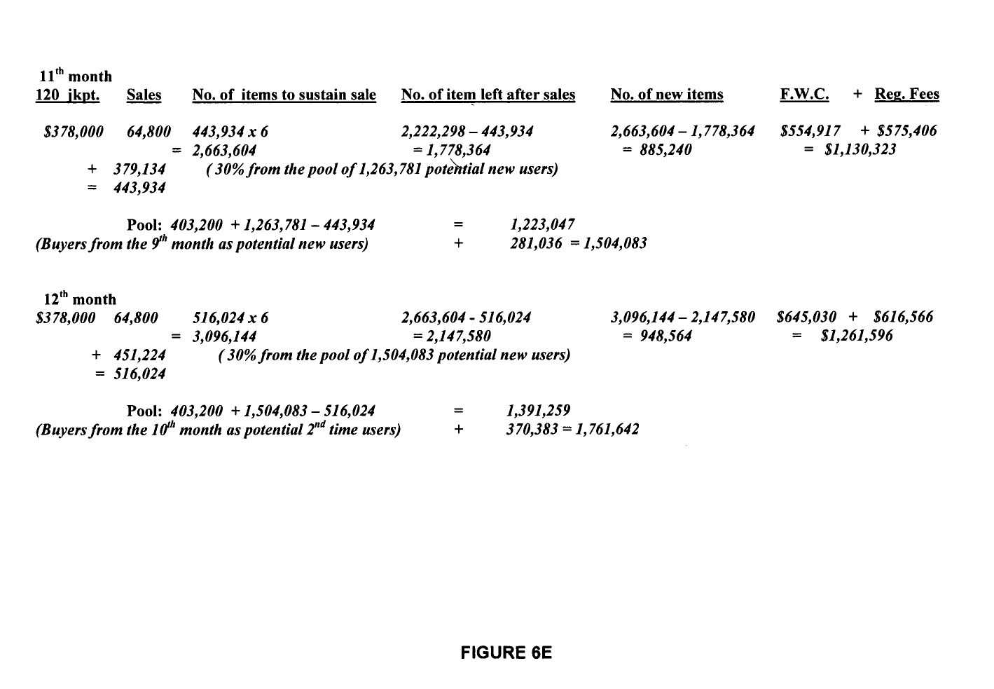

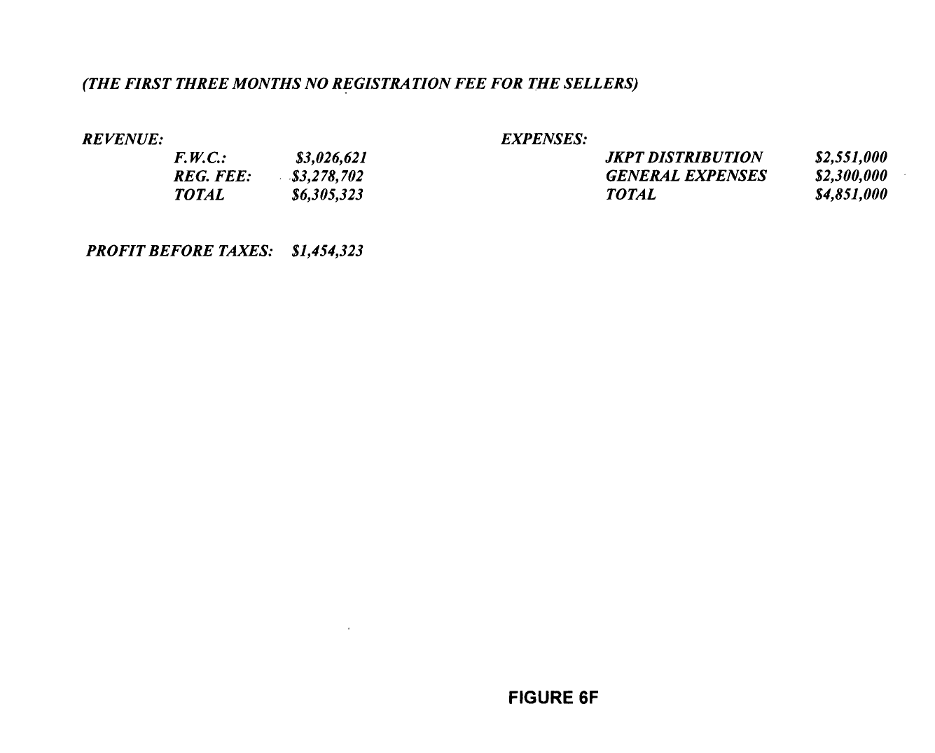

To better understand the impact of the trust-reciprocation method, a model business plan of the present invention is illustrated in FIGS. 6A, 6B, 6C, 6D, 6E, and 6F along with the implementation of the online auction of the present invention over the course of one year, broken down by month and day. FIGS. 6A-6F, however, are meant only as a desirable method of implementation as it can easily be seen that many of the monetary rewards, daily number of drawings or jackpots, amount of registration fees for each item on sale, implementation of the free will commission, types of advertising, and etc. can vary and yet still fit within the general principles of trust-reciprocation established by the present invention.

FIGS. 6A-6F are a proposed “BUSINESS PLAN—LIKELIHOOD OF REVENUE & CASH FLOW” showing a business projection for 1 year. As the business progresses in the system of the proposed model, the importance of the constant extension of the reward's distribution as a regulatory and control measurement should not be left unnoticed.

As depicted in FIG. 6A, there will be no registration fees through the first 3 months of the online auction in order to encourage new users to join. During the first month, an initial number of drawings—30 per day—will be established with an average drawing amount of $105. The amount of the drawing is a set amount. Although it is possible to base the monetary award based on a percentage of sales within a period of time, a set amount of money will have a more desirable effect on potential and current users of the present online auction method by issuing tickets to all sales, and both small and power users will benefit equally from winning the auction drawing or jackpot. It is expected that a certain amount of money will be earmarked by the OASP to supply the money from the drawing.

In the first month, because of the drawing, no initial registration fees, announcements of drawing winners, and because commissions are voluntary, an initial surge of new users are expected, conservatively, at 420 day based on the total number of drawings and also from general word-of-mouth. Additionally, new users expected from an initial advertisement phase are expected to be less dramatic at 120 day totaling 16,200 for the first month. Similarly, new sales from the addition of new users are expected to mirror the number of new users added each month.

As a result of the ongoing drawings primary and secondary effect and from the ongoing radio and newspaper advertisements, the potential number of users is also expected to be approximately 100,000 a month based on the current model.

As a basic example, FIG. 1 shows 30 drawings a day, from the 1^{st} to the 5^{th} month to increase to 120 a day for the 1^{st} year are projected with a starting inventory of 97,200 items (with no registration fees during the first three months).

As initially demonstrated in FIG. 6A, at the time of launching “AUCTION JACKPOT” it will need 97,200 pre-registered items in different categories in order to generate 12,960 sales in the first month. The ratio accepted here, for the number of items displayed to sustain one sale, is six registered items for one auction sale, which is a conservative ratio not to inflate the registration fees revenue in the present projection, for an intentional optimistic purpose. To secure this inventory of 97,200 items, a solution could be to form a strategic affiliation with associations of high volume sellers (power sellers). The company envisions offering some equity vehicles (prices and conditions to be established), which as secondary effect will motivate loyalty, enthusiasm and a sense of community in “AUCTION JACKPOT”.

In the pre-launching operation, the company will use all the channels available of free publicity. In the model used for the monthly business plan projection in FIGS. 6-11, during the first year, seven factors are considered:
1) Monthly Drawing Distribution value
2) Revenue
3) Number of New Sales
4) Number Of New Customers (Based on the auction drawing, word-of-mouth, and advertising)
5) Potential New Users
6) Entropy Progression (The proportionate increase in potential new users based on the increased awareness of the drawing)
7) Yearly Expenses (As shown in FIG. 6F, yearly expenses after the first full year can be considered to be app. 2.3 million dollars)

FIGS. 6B, 6C, 6D, 6E, and 6F all show the estimates for a sustained proportionate increase in the number of new sales, new customers, and number of potential new users based on an increasing number of drawings which, in turn increase the number of sales and the number of free will commissions. The same process is then repeated in successive years and will show a similar proportionate increase.

The trust-reciprocation method defines a more effective means of immediate and sustained online auction growth than existing models by attracting new customers and completed sales by offering constant daily rewards for those sales. It also achieves the same by allowing online auction participants to remain in control of their ability to sell or buy online through the elimination of arbitrary commissions and allowing them to voluntarily contribute their commissions from sales.

1. A method for conducting a reward structure in an online commercial transaction comprising the steps of:
sellers providing one or more items for sale through an online commercial transaction;
an online commercial transaction service provider announcing a promotional event through a computer system with a reward for the completed sales of any one of the items;
completing sales for the items by successful buyers and successful sellers;
sending notification to the online commercial transaction service provider of the completed sales;
issuing unique tickets to the successful buyers and the successful sellers for their completed sales and entering their tickets into the promotional event;
selecting a winning ticket at the time of the promotional event; and
giving the reward to the winning ticket holder.

2. The method of claim 1 wherein:
the online method of exchange is an online auction;
the items for sale are auction items;
buyers are bidders on the auction items; and
the promotional event is a drawing.

3. The method of claim 1 wherein:
the online method of exchange is an online auction;
the items for sale are auction items;
buyers are bidders on the auction items; and
there are multiple promotional events in the form of drawings.

4. The method of claim 1 wherein:
the online method of exchange is an online auction;
the items for sale are auction items;
buyers are bidders on the auction items;
there are multiple promotional events in the form of drawings; and
the drawings increase proportionately each succeeding month.

5. The method of claim 1 wherein a computer generated process selects the tickets randomly.

6. A method in a computer system for implementing commissions in an online commercial exchange comprising the steps of:
a seller providing an item for sale;
a buyer successfully purchasing the item;
the seller and buyer completing a sale for the item;
a provider of the online commercial exchange receiving notification of the sale;
the online commercial exchange provider sending a request to the seller for a voluntary commission as a result of the completed sale; and
the online commercial exchange provider receiving the voluntary commission from the seller.

7. The method of claim 6 wherein:
the online commercial exchange is an online auction;
the items for sale are auction items; and
buyers are bidders for the auction items.

8. The method of claim 6 wherein the voluntary commission is a percentage of the completed sale.

9. A method in a computer system for conducting a reward structure and implementing commissions in an online auction comprising the steps of:
online consumers providing one or more auction items for bid on the online auction;
the online auction service provider announcing a promotional event with a reward for the completed sales of any one of the auction items;
successful bidders and successful sellers completing sales for the auction items on the online auction;
the online auction service provider receiving notification of the completed sales;
sending a request by the online auction service provider to one of the online consumers for a voluntary commission;
receiving the voluntary commission from one of the online consumers;
issuing unique tickets by the online auction to the successful bidders and the successful sellers for their completed sales;
entering the tickets into the promotional event;
selecting a winning ticket at the time of the promotional event; and
giving the reward to the winning ticket holder.

10. The method of claim 9 wherein the promotional event is a drawing.

11. The method of claim 9 wherein:
there are multiple promotional events;
the promotional events are drawings; and
the drawings increase proportionately each succeeding month.

12. The method of claim 9 wherein the reward is for a monetary value.

13. The method of claim 9 wherein the reward is for a percentage of the total sales of a designated sales period.

14. The method of claim 9 wherein a computer generated process selects the tickets randomly.

15. The method of claim 9 wherein a computer generated process selects the ticket that corresponds to the largest completed sale of all the tickets entered.

16. The method of claim 9 wherein a computer generated process selects the ticket that corresponds to the buyers with the largest volume of sales.

17. The method of claim 9 wherein the voluntary commission is a percentage of the completed sale.

18. The method of claim 9 wherein the voluntary commission is a set monetary value.

19. The method of claim 9 wherein entering tickets into the promotional event is suspended for an insufficient voluntary commission by a non-contributing online consumer until the non-contributing online consumer voluntary contributes.

20. The method of claim 9 wherein:
a first bidder of an auction item is also the winning bidder of one of the auction items; and
the winning first bidder and the seller of one of the auction items each receives two tickets entered into the corresponding auction jackpot for the completed sale of one of the auction items.
